(19) United States
(12) Patent Application Publication
(10) Pub. No.: US 2009/0095387 A1
(43) Pub. Date: Apr. 16, 2009

(54) Tire With Tread Having Full Depth Siping

(75) Inventor: Olivier De Barsy, Eischen (LU)

Correspondence Address: DAVID L. KING, SR., 5131 N.E. COUNTY ROAD 340, HIGH SPRINGS, FL, 32643, US

(73) Assignee: THE GOODYEAR TIRE & RUBBER CO., Akron, OH (US)

(21) Appl. No.: 11/872,188

(22) Filed: Oct. 15, 2007

(51) Int. Cl. B60C 11/24; B60C 11/03

(52) U.S. Cl. 152/154.2; 152/209.25

(57) ABSTRACT

A tread 10 for a tire 2 has a plurality of tread elements or ribs 6, the shape of these tread ribs 6 is defined by a plurality of open grooves 12. The tread 10 has at least one full depth groove 12. The full depth groove 12 has a radially innermost groove bottom 14 providing a measuring location to establish the distance between the groove bottom 14 and outer surface of the tread 10 defining the tread depth. At least one tread rib 6 adjacent the at least one full depth groove 12 has one or more sipes 21, 22, 22A, or 24 extending radially inwardly from a radially outermost surface of the tread rib 6 inwardly to a depth greater than the distance X. The distance X defines a fully worn tread depth level extending radially above the full depth groove bottom 14. Preferably the location X is defined by a tread wear indicator (TWI) molded into the tread indicating the location of the distance X relative to the groove bottom 14 which defines the fully worn tread depth.

### FIELD OF THE INVENTION

The present invention relates to tires generally, more specifically to tires having treads with narrow grooves called sipes.

### BACKGROUND OF THE INVENTION

Tire treads are molded in such a way to create a pattern of groove voids for the drainage of water and to provide tread edges to give the tire traction on the road surfaces. Grooves are typically wide enough to remain open as the tire rolls through the portion of the tread contacting the roadway. The tread depth, also called the “non-skid depth”, is typically established as the distance between the outer surface of the tread and the deepest grooves as measured at the groove base or bottom. Often these deepest grooves are circumferentially continuous grooves, but can be inclined or lateral extending grooves depending on the tread pattern.

As the tread wears beyond a certain depth, many countries dictate the tires be replaced because the grooves creating these water drainage paths decrease in size making them inefficient in removing the water.

At tread thickness of 2.0 mm or less the tires are often required by safety laws to be removed. Tread wear indicators (TWI's) are often molded into the base of the full depth grooves to provide a way of telling when a tire must be replaced.

Another type of very narrow incision provides a type of groove that is so narrow it closes in the footprint or road contact patch as the tire rotates. These narrow grooves are often referred to as sipes, and sipes form additional edges in the rib or block shaped tread elements that add significantly to the tires traction performance in all road conditions. These sipes don't drain water in the same way an open wide groove does, but nonetheless the extra edges provide meaningful improvements in traction.

One significant drawback to the use of sipes is they are prone to cause cracking in the tread element if not carefully designed, particularly so when the sipe cuts into a wall tread element open to a wide groove at location where stress is already increased due to presence of other design elements. For that problem to be avoided, tire designers have made the blades short, that is the blade used to form the sipe extends radially inwardly a distance well above the tread wear indicators, typically 4 mm or more above the base of the full depth grooves. As can be easily appreciated this means as the tread is worn down, the sipes disappear long before the tire must be replaced. This further means that as the tire tread decreases in ability to drain water from its worn shallow groove voids it also completely loses the benefit of the traction edges created by the sipes.

The present invention as described as follows provides a unique and novel solution that not only enables these sipe edges to remain until the tire is fully worn, it has done so in a way that avoids cracks being developed in the tread edges.

### SUMMARY OF THE INVENTION

A tread for a tire has a plurality of tread elements, the shape of these tread elements is defined by a plurality of open grooves. The tread has at least one full depth groove. The full depth groove has a radially innermost groove bottom providing a measuring location to establish the distance between the groove bottom and outer surface of the tread defining the tread depth. At least one tread element adjacent the at least one full depth groove has one or more sipes extending radially inwardly from a radially outermost surface of the tread element inwardly to a depth greater than the distance X. The distance X defines a fully worn tread depth level extending radially above the full depth groove bottom. Preferably the location X is defined by a tread wear indicator (TWI) molded into the tread indicating the location of the distance X relative to the groove bottom which defines the fully worn tread depth.

In a preferred embodiment the at least one sipe extends across at least a portion of the at least one tread element's radially outermost surface through a sidewall of the tread element connecting the at least one sipe to the at least one full depth groove. The sidewall has a curved radially inner portion extending to the groove bottom of the at least one full depth groove and the sipe extends through the curved portion to the groove bottom having a maximum depth preferably equal to or greater than the full depth groove bottom.

In at least one embodiment the tread has a plurality of full depth grooves and a plurality of tread elements. Each tread element has one or more sipes, at least one of these sipes within each tread element extending at least a distance Z to beyond the tread wear indicator level X, preferably extending to the full depth of the tread and intersecting a full depth groove at the groove bottom.

### DEFINITIONS

The following definitions are applicable to the present invention.

“Groove” means an elongated void area in a tread that may extend circumferentially or laterally about the tread in a straight curved, or zigzag manner. Circumferentially and laterally extending grooves sometimes have common portions and may be sub classified as “wide”, “narrow”, or “sipe”. The sipe typically is formed by steel blades inserted into a cast or machined mold or tread ring therefore. Grooves, as well as other voids, reduce the stiffness of tread regions in which they are located. Sipes often are used for this purpose, as are laterally extending narrow or wide grooves. Grooves may be of varying depths in a tire. The depth of a groove may vary around the circumference of the tread, or the depth of one groove may be constant but vary from the depth of another groove in the tire. If such narrow or wide groove is of substantially reduced depth as compared to wide circumferential grooves which they interconnect, they are regarded as forming “tie bars” tending to maintain a rib-like character in the tread region involved.

“Inner” means toward the inside of the tire and “outer” means toward its exterior.

“Outer” means toward the tire's exterior.

“Radial” and “radially” are used to mean directions radially toward or away from the axis of rotation of the tire.

“Tread” means a molded rubber component which, when bonded to a tire casing, includes that portion of the tire that comes into contact with the road when the tire is normally inflated and under normal load. The tread has a depth conventionally measured from the tread surface to the bottom of the deepest groove of the tire.

### BRIEF DESCRIPTION OF THE DRAWINGS

The invention will be described by way of example and with reference to the accompanying drawings in which:

FIG. 1 illustrates a perspective view of an exemplary tread made according to the present invention.

FIG. 2 is a plan view of the exemplary tread of FIG. 1.

FIG. 3 is an enlarged portion taken from the plan view of FIG. 2 showing a portion of the tread.

FIG. 4 is a cross section of the tire with the tread portion made according to the present invention.

FIG. 5 is a cross sectional view of a prior art tread element showing the depth of a sipe or incision according to the prior art.

FIG. 6 is a view taken along line 6-6 of the prior art cross section of FIG. 5, FIG. 6 illustrates the depth of the prior art blade relative to the base of the tread relative to the groove bottom of the tread and showing the sipe significantly above the tread wear indicator (TWI).

FIG. 7 is a cross sectional view of the sipe or incision of the present invention.

FIG. 8 is an end view taken along the lines 8-8 from FIG. 7 showing the depth of the sipe.

### DETAILED DESCRIPTION OF THE INVENTION

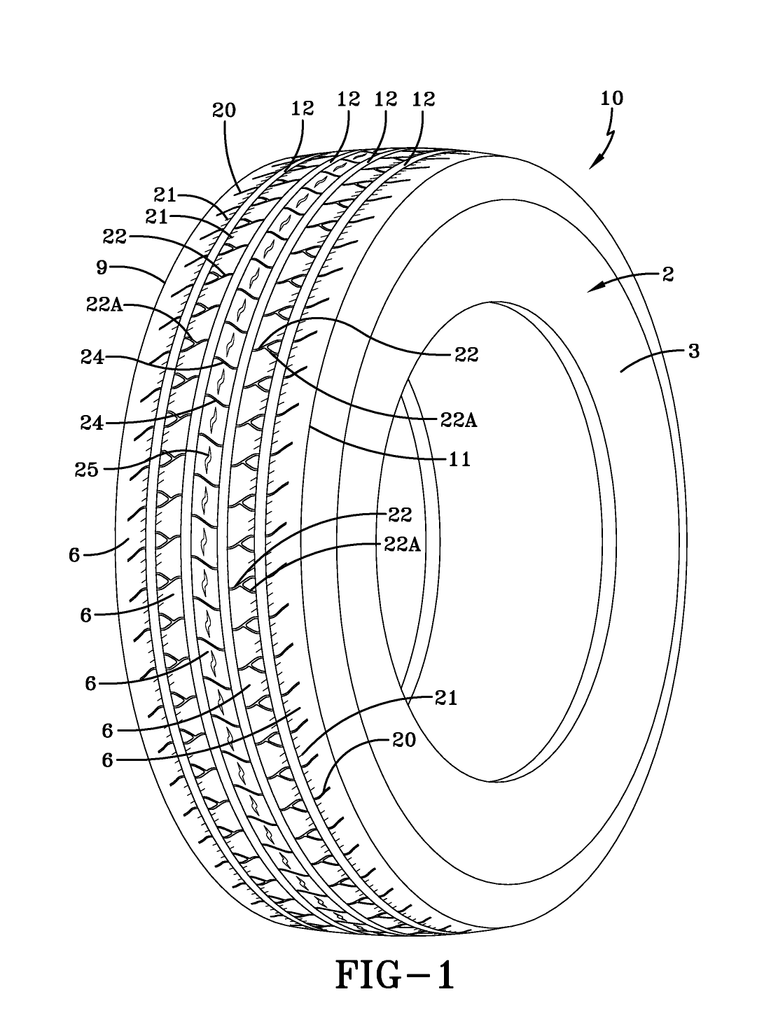

With reference to FIG. 1 a tire 2 made according to the present invention is shown, the tire 2 has a radially outer tread 10, the tread 10 generally extends around the outermost surface of the tire carcass 3. As shown the tread 10 has a plurality of wide full depth circumferentially extending grooves 12 that define tread elements as shown in the shape of ribs 6. These ribs 6 extend circumferentially around the tire 2 as shown. The ribs 6 on the outer lateral edges 9, 11 of the tread 10 extend inwardly and include a plurality of superficial grooves 20 extending from a portion of the rib 6 to a wide circumferential groove 12 between each of these superficial grooves 20 are a plurality of small incisions or small sipes 21 used to help reduce rib edge wear. Radially inward of the outermost or the laterally outer ribs 6 is an intermediate rib 6 on each side of the center plane (CP) of the tire 2. The intermediate rib 6 as illustrated shows the plurality of incisions or sipes 22 that extend completely across the tread rib 6 from one full depth groove 12 to another full depth groove 12 on the opposite of the rib 6. This sipe is in the shape of an “S”. This sipe is coupled with a superficial groove that has a branched section 22A that intersects the sipe 22 as it extends across the tread element at a mid point and extends outward to intersect one groove 12. Additionally, there are small bladed sipes 21 as illustrated that open into the circumferential groove as well. At the center plane (CP) of the tread 10 is shown a circumferentially continuous tread rib 6. This tread rib 6 also has narrow sipes or incisions 24 that extend laterally across the tread rib 6 additionally circumferentially extending blind grooves 25 are included in between each sipe 24 as illustrated.

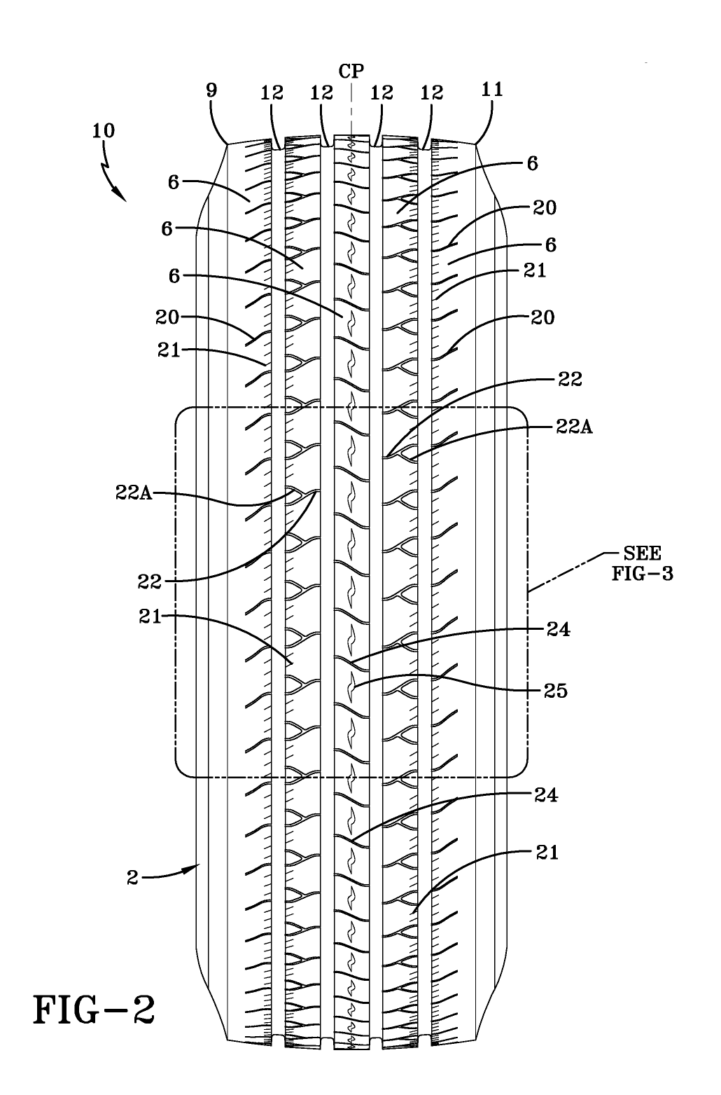

FIG. 2 illustrates a plan view of the tread 10 as described above.

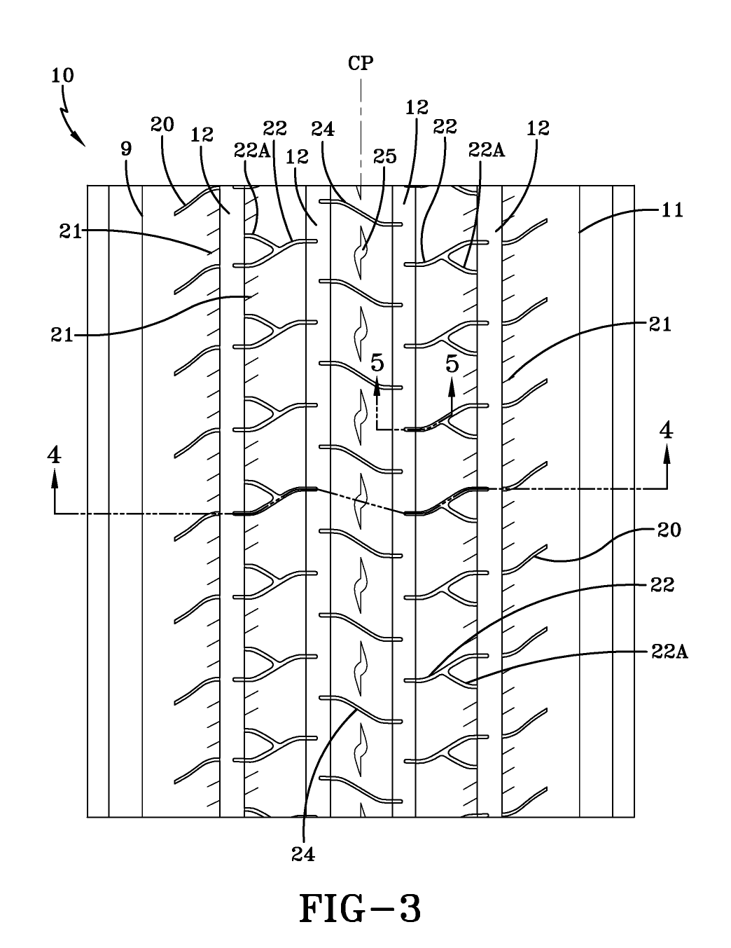

With reference to FIG. 3 an enlarged portion of that tread 10 shown in FIGS. 1 and 2 is illustrated.

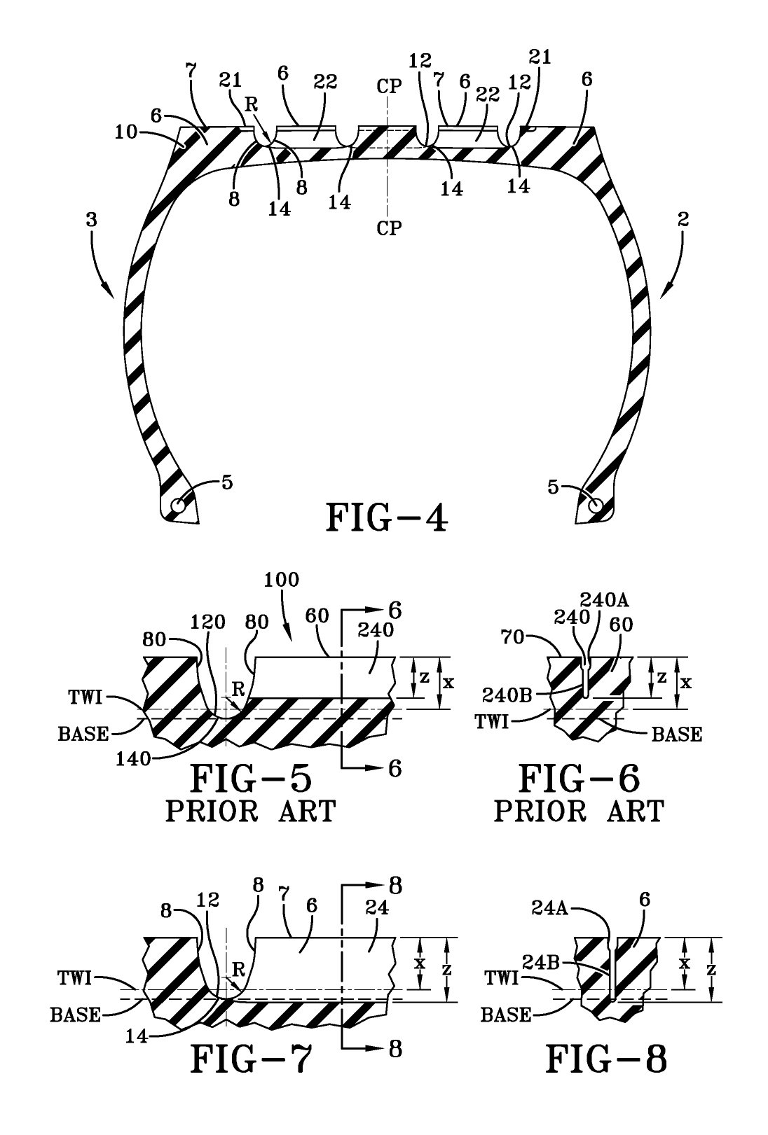

A cross sectional view taken across lines 4-4 is shown in FIG. 4. The cross sectional view shows the entire tire 2 having beads 5 at the radially innermost portion of the tire 2 and the radially outermost portion or crown of the tire carcass 3 showing the tread 10. As shown in the cross section the circumferentially extending grooves 12 extend from a full depth to a groove bottom 14 as illustrated. As shown each groove 12 has a radius of curvature R extending radially outward from the groove bottom 14 to the groove wall 8 which extends to a radially outermost surface 7 of the ribs 6. As shown in the cross section of FIG. 4 the laterally outermost tread ribs 6 do not show the full depth of the narrow grooves or sipes 20 as illustrated, however, at the intermediate ribs 6 the full depth sipes 24 can be seen extending across the entire rib 6 as illustrated. As shown the sipes 24 extend radially inwardly cutting through the sides or groove walls 8 to the base or bottom 14 of the tread grooves 12 as shown.

With reference to FIG. 5 an exemplary portion of a tread 100 is shown according to the prior art. In this tread 100 it can easily be appreciated that the full depth groove 120 extends normally to the groove bottom 140 as illustrated by the dashed line. This groove bottom 140 extends radially outward in a curved fashion as shown and forms the sides or groove walls 80 of the adjacent tread rib 60 in this case the laterally outer rib 60 and an intermediate rib 60. As shown the sipe 240 according to the prior art extend to a depth Z above the location X where a TWI level shown by a dashed line shows the fully worn level of the tread 100. These TWI's (not shown) typically are positioned in the base of the grooves 120 and extend outwardly a distance between 1.6 and 2.0 mm depending on the local requirements mandated by law generally. These TWI's provide the user with an easy indication of when the tread is fully worn and the tire should be replaced and removed from the vehicle. As shown the sipes 240 extend from the radially outermost surface 70 of the tread 100 inwardly to the distance Z directly above the TWI level X. The edges of the sipe 240 open into the side or groove wall 80 of the full depth groove, but not at full depth, but well above the TWI level X to avoid the radius of curvature R at the bottom of the groove 140.

The cross sectional view of FIG. 6 shows fundamentally shows how this type of sipe 240 would appear in terms of its depth relative to the tread's outer surface 70. As shown the sipe 240 has a wider upward portion 240A and a significantly narrow portion 240B as it extends radially inwardly to a shortened depth ending at Z.

With reference to FIG. 7, a cross sectional view is shown only with the sipe 24 made according to the present invention it being understood sipes 20, 22, and 22A also are or can be made to the extended depths identical to sipe 24 as shown. In this situation the sipe 24 extends at or below the depth of the full depth groove bottom 14 and as such opens from a side or groove wall 8 of the rib 6 into the full depth groove 12 and even opens through the radius of curvature R along the wall 8 of the groove 12 into the base or bottom 14 of the groove 12 as shown. This feature enables one to look into the groove 12 from a top view and to see open portions of the sipes 20, 22, 22A and 24 extending directly into the base or bottoms 14 of the grooves 12 open along the entire side or groove wall 8 and extending across the outer surface 7 of the rib 6 as illustrated in FIG. 3. In the illustrated embodiment, the incision or sipe 24 actually cuts into the tread rib 6 a distance Z shown below the level of the base of the groove 12, however, it is believed novel that the sipe 24 extends at least below the TWI level X and through the radius of curvature R of the or rib 6 to a depth Z near the base or bottom 14 of the full depth groove 12.

FIG. 8 illustrates this in cross sectional view, wherein the radially outermost portion 24A of sipe 24 is slightly enlarged wherein a much longer extension 24B of the sipe 24 occurs into the tread element extending to the distance Z at least to a depth below the tread wear indicator level TWI, as shown Z is below the tread base line. As can easily be appreciated as the tread wears wherein the ribs 6 are being reduced in height, the total volume of drainage available for the circumferential grooves 12 is dramatically reduced. The radially outer surface 7 of the tread ribs 6 will continue to decrease until it reaches the tread wear indicator (TWI) level X at this location once the tread 10 is fully worn, the sipes 20,22,22A or 24 will have formed incisions that will survive and still be exposed during this worn condition in the tire 2. This is significant in that normally these sipes are fully erased as the tread wears such that the tread element would become solid ribs 6 as the tire's worn condition is reached. In the present invention the blade forming the sipes when the tire is molded extends beyond the TWI level X to a distance Z much deeper and as a result when the tread 10 reaches the fully worn condition these sipes will still provide biting edges in the tread rib 6. This has tremendous advantage in that the biting edges of the incisions or sipes 21,22,22A or 24 add additional traction. This additional traction is maintained throughout the life of the tire 2 and does not diminish as the tread wears to its full worn depth.

With reference to FIG. 5 as can be seen the prior art tread 100 has sipes 240 that would generally stop well above the TWI level X to avoid the area where the curvature R of the groove 120 exists. This area is a typical high risk area for cracks. The reason for this is that this is the most critical location for stress fractures (a site prone for stress/fatigue marks) is located approximately where the TWI dashed line X is indicated along the rising slope of the center of the groove bottom radius R at an angular location 45 degrees from the groove bottom 140. The solution arrived at avoiding this location of crack formation was to make the sipe deeper not shallower in order that the sipe would end below the rising slope at the center of the groove bottom 140.

Referring back to FIG. 1, the tire 2 as shown is a long haul steer tire and is designed for commercial trucks and heavy vehicles. Typically, this tread 10 has a non-skid depth of 13 to 20 mm, this non-skid or tread depth can be made 20 percent lower with the use of the sipes 20, 22, 22A or 24 according to the present invention and one could optionally change the tread compound from a high wear resistant one to a cool running compound accepting lower mileage removal, but achieving a cooler running tire. By using a lower non-skid where the tread's overall life may be slightly reduced, the rolling resistance is dramatically improved such that the fuel efficiency of the vehicle can achieve much greater performance and as such the overall cost of operating the vehicle can be reduced even though the tires may be replaced more rapidly. Alternatively, the tread 10 can be made at its full depth of 13 to 20 mm and the advantage of improved traction through the full life of the tire 2 will be achieved by using these extended depth sipes 20, 22, 22A and 24. Currently there's been a move to achieve greater fuel efficiency for vehicles and as a result the concept of providing a lower non-skid depth initially, but by providing deeper blades that match the groove depth of the full depth groove would enable a vehicle to operate with greater fuel efficiency without sacrificing traction during the life of the tire. These commercial trucks have a tread base above the belt reinforcing structure that typically would permit the use of such deeper sipes as proposed in the present invention. Alternatively even in other light truck and passenger tires, the advantages of providing the longer depth incisions or sipes according to this invention would mean that ice, snow and wet traction would be superior from what is currently achieved in tires as a result of having the biting edges of the sipes remain through the full life of the tire. It is generally recognized that wet traction performance is greatest when the tire is new with regard to grooves sipes. However, this traction diminishes significantly as the tire wears to the fully worn condition. The present invention tries to minimize this drop off in efficiency by providing incisions or sipes that would be available for the entire tread life of the tire. While the representative example shown in the figures utilized a tread pattern having tread elements in the shape of ribs 6 it is understood that the present invention can be applied in any tread pattern including those using block shaped tread elements or other shaped tread elements wherein not only long continuously extending circumferential grooves are employed, but also lateral grooves in combination with the deep sipes according to the present invention.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tread for a tire having a plurality of tread elements the shape of each tread element is defined by a plurality of open grooves, the tread comprising:
at least one full depth groove, having a radially innermost groove bottom defining an innermost location for measuring the tread depth,
a fully worn tread wear depth level extending radially above the full depth groove bottom a distance X, and
at least one tread element adjacent the at least one full depth groove, the at least one tread element having one or more sipes extending radially inward from an outer surface of the tread element inwardly to a depth greater than the distance X.

2. The tire tread of claim 1 further comprises:
a tread wear indicator molded into the tread indicating the location of the distance X, defining the fully worn tread depth.

3. The tread of claim 1 wherein the at least one sipe extends across at least a portion of the at least one tread elements radially outermost surface through a side wall of the tread element open or connecting to the at least one full depth groove.

4. The tread of claim 3 wherein the sidewall has a curved radially inner portion extending to the groove bottom of the at least one full depth groove and wherein the sipe extends through the curved portion to the groove bottom having a maximum depth equal to or greater than the full depth groove bottom.

5. The tread of claim 2 wherein the tread has a plurality of full depth grooves and a plurality of tread elements each tread element having one or more sipes, at least one of said sipes within each tread element extending at least the distance X.

6. The tread of claim 5 wherein the at least one sipe within each tread element extends to the full depth of the tread and intersects a full depth groove at the groove bottom.
